(19) United States
(12) Patent Application Publication
(10) Pub. No.: US 2021/0318423 A1
(43) Pub. Date: Oct. 14, 2021

(54) Proximity Detection Using Calculated Voltage Standing Wave Ratio Readings

(71) Applicant: Google LLC, Mountain View, CA (US)

(72) Inventors: Jibing Wang, San Jose, CA (US); Erik Richard Stauffer, Sunnyvale, CA (US); Aamir Akram, San Jose, CA (US)

(73) Assignee: Google LLC, Mountain View, CA (US)

(21) Appl. No.: 16/970,589

(22) PCT Filed: Sep. 27, 2019
(86) PCT No.: PCT/US2019/053654

§ 371 Date: Aug. 17, 2020

(51) Int. Cl. G01S 13/04; H01Q 3/26; H01Q 3/36; G01S 7/41; G01S 7/03

(52) U.S. Cl. CPC G01S 13/04; H01Q 3/2605; G01S 7/03; H01Q 3/267; G01S 7/417; H01Q 3/36

(57) ABSTRACT

The present disclosure describes methods, devices, systems, and procedures for detecting a proximity of an object (301) in a near-field region of an electromagnetic field of a transmitting antenna array (204; 304; 404) using a voltage standing wave ratio (VSWR). In aspects, a forward signal for transmission by the antenna elements (308) is generated, at least one VSWR detector (210; 310) coupled to the antenna array (204; 304; 404) measures a power of the forward signal, the forward signal is transmitted, the at least one VSWR detector (210; 310) measures a power of a reflected signal, and the VSWR detector (210; 310) calculates a VSWR. Detected changes in the calculated VSWR are then utilized to detect object (301) proximity in the near-field region. Beamforming weights may be applied to the forward signal and a machine-learned model can be utilized to detect object (301) proximity in the near-field region.

### BACKGROUND

A user equipment, such as a smartphone, may include an antenna module that includes a transceiver module and a plurality of antenna elements disposed in one or one or more antenna arrays. The transceiver module may include one or more transceivers. The transceiver module connects to the antenna elements through a radio-frequency (RF) conductor.

To improve power transfer between a transceiver and its load (e.g., the antenna), the specified load impedance of the transceiver is matched to the combined input impedance of the antenna (e.g., antenna elements) and the RF conductor. Through impedance matching, reflected power (return loss) is minimized, enabling power to be efficiently transferred between the transceiver and the antenna.

The close-in region of the electromagnetic field around a transmitting antenna is referred to as the near-field region. In the near-field region, the absorption of radiation by objects affects the load on the transceiver. For example, the presence of an object (e.g., body, head, extremity, hand) in the near-field region around a transmitting antenna may result in an interaction between the transmitted RF waves and the object's medium (e.g., body capacitance). This interaction alters antenna impedance matching and causes a portion of the radio-frequency energy of the forward (transmission) signal to reflect back to the transmitting antenna, resulting in reflected power (return loss) in the RF transmission circuit of the antenna module.

When a reflected signal (reflected power) is present in an RF transmission circuit, the reflected power interacts with the forward power to create standing waves in the RF conductor, resulting in the distortion of the forward signal and decreasing the efficient transfer of power between the transceiver and antenna. The standing waves caused by the interaction of the reflected power and the forward power have a voltage maximum (Vₘₐₓ) and a voltage minimum (Vₘᵢₙ) that can be measured and a voltage standing wave ratio (VSWR), a measurement of the level of standing waves caused by the interaction of the reflected power and forward power, can be calculated. For example, a VSWR value of 1.5:1 would denote an alternating current (AC) voltage due to standing waves along the RF conductor reaching a peak value 1.5 times that of the minimum AC voltage along the RF conductor. Alternatively, a standing wave ratio can be defined as the ratio of the maximum amplitude to minimum amplitude of the RF conductor's currents, electric field strength, or the magnetic field strength.

Original equipment manufacturers may utilize one or more proximity sensors located on the UE. These proximity sensors generate proximity data indicative of the UE being located proximate to an object (e.g., a user's body, a portion thereof (e.g., head, hand)). The utilization of proximity sensors in UE may increase manufacturing costs and consume valuable space on the user equipment. Further, the accuracy of such proximity sensors is less than ideal. As a result, improvements in UE are needed.

### SUMMARY

This summary is provided to introduce simplified concepts of proximity detection using calculated voltage standing wave ratio (VSWR) readings. The simplified concepts are further described below in the Detailed Description. This summary is not intended to identify essential features of the claimed subject matter, nor is it intended for use in determining the scope of the claimed subject matter.

Aspects described below include a method for proximity detection using calculated VSWR readings. In particular, the method detects an object in a near-field region of an electromagnetic field of a millimeter-wave transmitting antenna array formed from a plurality of millimeter-wave antenna elements using calculated VSWR readings. The method includes generating a forward signal for transmission by the plurality of antenna elements. The method also includes generating beamforming weights using a controller and applying the beamforming weights to the forward signal to generate a weighted forward signal using phase shifters. The method additionally includes measuring the power of the weighted forward signal using at least one VSWR detector that is coupled to the transmitting antenna array. In addition to transmitting the weighted forward signal, the method includes measuring the power of a reflected using at least one VSWR detector. The method also includes calculating a VSWR based on the power of the weighted forward signal and the power of the reflected signal using at least one VSWR detector. By interactively measuring subsequent forward signals, measuring subsequent reflected signals, and determining the VSWR, the method additionally includes detecting a change in the VSWR. The method further includes detecting the proximity of the object in the near-field region based on the detected change in the VSWR.

Aspects described below include another method for proximity detection using calculated VSWR readings. In particular, the method detects an object in a near-field region of an electromagnetic field of a millimeter-wave transmitting antenna array formed from a plurality of millimeter-wave antenna elements using calculated VSWR readings. The method includes generating a forward signal for transmission by the plurality of antenna elements. The method also includes measuring a power of the forward signal at each of the antenna elements using a plurality of VSWR detectors. Each VSWR detector couples to one of the antenna elements. In addition to transmitting the forward signal, the method includes measuring a power of a reflected signal at each of the antenna elements using each VSWR detector. The method also includes calculating a VSWR for each of the antenna elements based on the power of the measured forward signal and the power of the measured reflected signal using each VSWR detector. By iteratively measuring subsequent forward signals, measuring subsequent reflected signals, and determining the VSWR, the method additionally includes detecting a change in the VSWR. The method further includes detecting the proximity of the object in the near-field region based on the detected change in the VSWR.

Aspects described below also include a user device comprising a processor and a computer-readable storage medium. The computer-readable storage medium stores instructions that, responsive to execution by the processor, cause the processor to execute any of the methods described.

Aspects described below also include a system with means for performing proximity detection using calculated voltage standing wave ratio readings.

The details of one or more methods, devices, systems, and procedures for proximity detection using calculated VSWR readings are set forth in the accompanying drawings and the following description. Other features and advantages will be apparent from the description and drawings, and the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of proximity detection using calculated voltage standing wave ratio (VSWR) readings are described with reference to the following drawings. The use of the same reference numbers in different instances in the description and the figures may indicate like elements:

FIG. 1 illustrates an example operating environment in which various aspects of proximity detection using calculated VSWR readings can be implemented;

FIG. 2 illustrates an example device diagram for a user equipment that can implement various aspects of proximity detection using calculated VSWR readings in accordance with one or more aspects;

FIG. 3 illustrates an example beamforming architecture for proximity detection using calculated VSWR readings in accordance with one or more aspects;

FIG. 4 illustrates a second example beamforming architecture for proximity detection using calculated VSWR readings in accordance with one or more aspects;

FIG. 5 illustrates an example method for proximity detection using calculated VSWR readings in accordance with one or more aspects; and

FIG. 6 illustrates an example method for proximity detection using calculated VSWR readings in accordance with one or more aspects.

### DETAILED DESCRIPTION

This document describes methods, devices, systems, and procedures for proximity detection using calculated voltage standing wave ratio (VSWR) readings. In aspects, a user equipment (UE) analyzes at least one characteristic of an RF signal to determine a VSWR. Based on changes in the determined VSWR, the UE determines the proximity of an object (e.g., a hand, a head) in the near-field region of a transmitting antenna of the UE. For example, the UE measures a forward signal, measures a reflected signal, and calculates a VSWR—a measurement of the level of standing waves caused by the interaction of the reflected power and the forward power. The UE then determines if the VSWR readings change. Responsive to determining that the VSWR readings have changed, the UE utilizes the calculated VSWR readings to determine the proximity of an object (e.g., a hand, a head) in the near-field region of the transmitting antenna. In aspects, the UE utilizes one or more VSWR detectors coupled with multiple antenna elements and beamforming techniques to detect the proximity of an object in the near-field. In aspects, a machine-learned model is applied to the determined VSWRs, the machine-learned model trained to determine the proximity of the object in the near-field region from VSWR measurements, and a detected proximity of the object in the near-field region is obtained from the machine-learned model.

Through the implementation of such techniques, a UE 110 can perform proximity detection apart from utilizing a proximity sensor located on the UE 110, thereby conserving battery life, freeing resources, and providing responsive and reliable object detection.

While features and concepts of the described methods, devices, systems, and procedures for proximity detection using calculated VSWR readings can be implemented in any number of different environments, systems, devices, and/or various configurations, aspects are described in the context of the following example devices, systems, and configurations.

Operating Environment

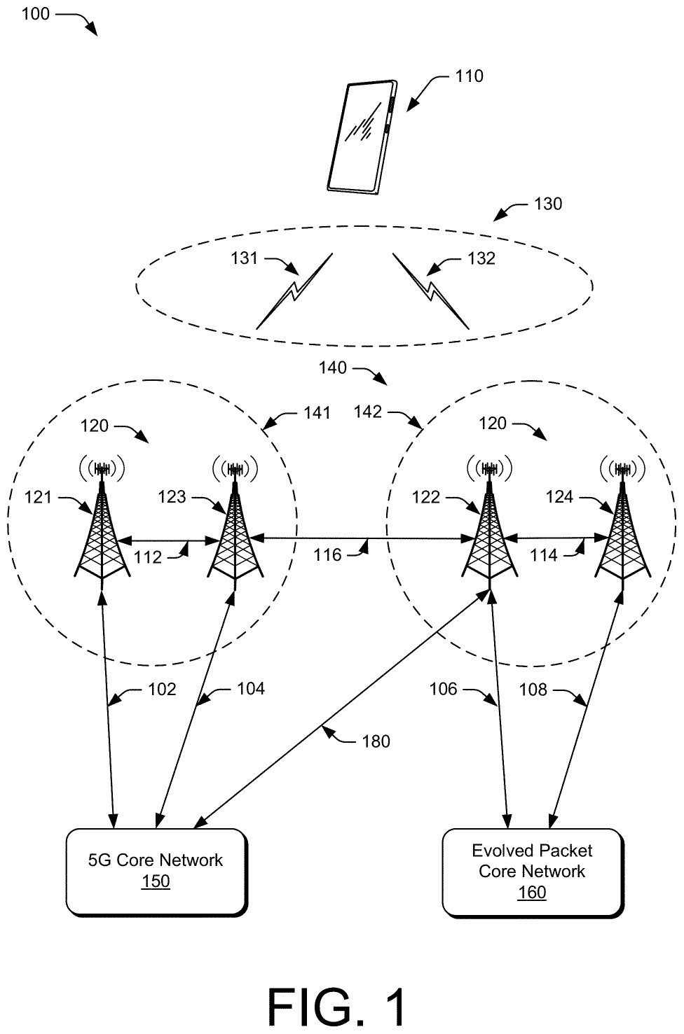

FIG. 1 illustrates an example operating environment 100 in which various aspects of proximity detection using calculated VSWR readings can be implemented. In the operating environment 100, a UE 110 communicates with one or more base stations 120 (illustrated as base stations 121, 122, 123, and 124) through one or more wireless communication links 130 (wireless link 130), illustrated as wireless links 131 and 132. In this example, the UE 110 is implemented as a smartphone. Although illustrated as a smartphone, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, or the like or the like that implements an ETM surface as described herein. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof.

The base stations 120 communicate with the UE 110 through the wireless links 131 and 132, which may be implemented as any suitable type of wireless link. The wireless link 131 and 132 can include a downlink of data and control information communicated from the base stations 120 to the UE 110, an uplink of other data and control information communicated from the UE 110 to the base stations 120, or both. The wireless links 130 may include one or more wireless links or bearers implemented using any suitable communication protocol or standard, or combination of communication protocols or standards such as third-generation partnership project long-term evolution (3GPP LTE), fifth-generation new radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a radio access network 140 (RAN, Evolved Universal Terrestrial Radio Access Network, E-UTRAN, 5G NR RAN or NR RAN). In FIG. 1, two RANs 140 are illustrated, an NR RAN 141 and an E-UTRAN 142. The base stations 121 and 123 in the NR RAN 141 connect to a fifth-generation core 150 (5GC 150) network. The base stations 122 and 124 in the E-UTRAN 142 connect to an evolved packet core 160 (EPC 160). Optionally or additionally, the base station 122 may connect to both the 5GC 150 and EPC 160 networks.

The base stations 121 and 123 connect, at 102 and 104 respectively, to the 5GC 150 using an NG2 interface for control-plane signaling and using an NG3 interface for user-plane data communications. The base stations 122 and 124 connect, at 106 and 108 respectively, to the EPC 160 using an Si interface for control-plane signaling and user-plane data communications. Optionally or additionally, if the base station 122 connects to the 5GC 150 and EPC 160 networks, the base station 122 connects to the 5GC 150 using an NG2 interface 180 for control-plane signaling and using an NG3 interface for user-plane data communications.

In addition to connections to core networks, base stations 120 may communicate with each other. The base stations 121 and 123 communicate using an Xn interface at 112. The base stations 122 and 124 communicate using an X2 interface at 114.

Furthermore, within the environment 100, the UE 110 may wirelessly communicate with the base stations 120 through the wireless communication links 130, during which electromagnetic waves, or signals, are transmitted or received by one or more antenna arrays that are part of the UE 110. In an instance where the UE 110 is communicating by the transmission of a signal, in certain instances, the UE 110 may employ one or more antenna elements of an antenna array to perform a beamforming operation. Such a beamforming operation may, via principles of constructive and destructive interference, form a directional path of the signal or an amplitude of the signal.

Example Devices

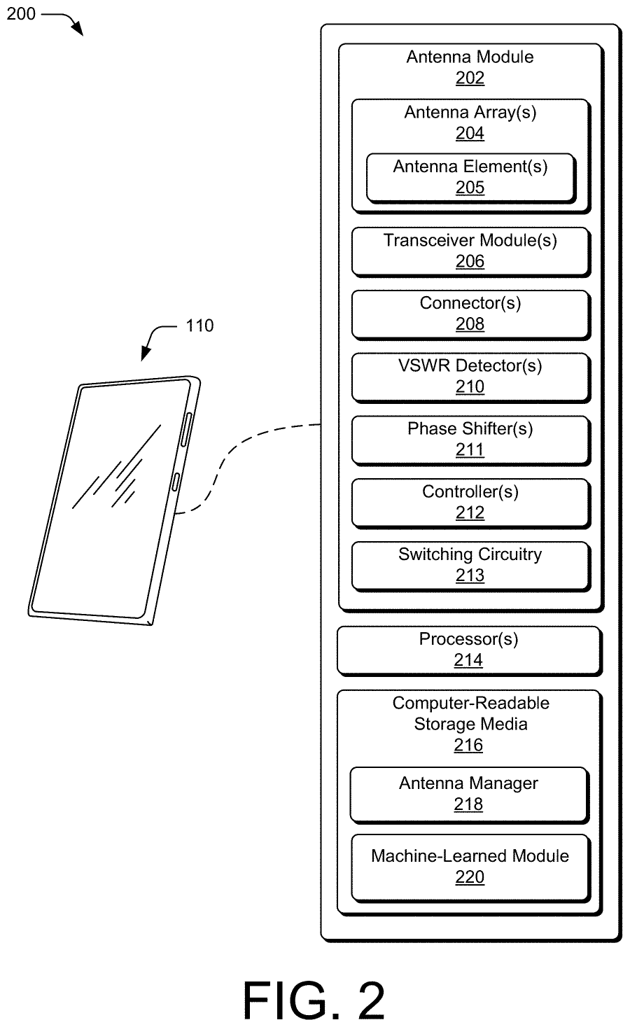

FIG. 2 illustrates an example device diagram 200 for a UE (e.g., the UE 110 of FIG. 1) that can implement various aspects of proximity detection using determined VSWR readings in accordance with one or more aspects. The UE 110 may include additional functions and interfaces that are omitted from FIG. 2 for the sake of clarity.

The UE 110 includes an antenna module 202 (e.g., a phased-array antenna module, a millimeter-wave (mmWave) antenna module, a mmWave phased-array module). In aspects, the antenna module 202 includes one or more transmitting antenna arrays 204. Each transmitting antenna array 204 is formed from a respective plurality (e.g., four antenna elements, eight antenna elements) of antenna elements 205 (e.g., mmWave antenna elements). In aspects, signals that respectively propagate through the antenna elements 205 may be adjusted in phase by different amounts from one another to enable the transmitting antenna array 204 to operate as a phased array.

The UE 110 includes one or more transceiver modules 206 (e.g., mmWave radio units) that include one or more transceiver devices that output (generate) a forward signal (transmitted power output) carried by one or more connector(s) 208 and transmitted using the antenna elements 205 of the transmitting antenna array(s) 204 in the form of electromagnetic waves. Furthermore, and in certain instances, the transceiver module(s) 206 may transmit and receive electromagnetic waves at frequencies ranging from, for example, 30 gigahertz (GHz) to 300 GHz (commonly referred to as the millimeter band). The wavelengths of these signals can range from 10 mm in length down to 1 mm in length. Radiation in the millimeter band is commonly referred to as millimeter waves (mmWave).

In aspects, each transmitting antenna array 204 can be tuned to, and/or be tunable to, one or more frequency bands defined by communication standards and implemented by each transceiver module 206. As an example, each of the transmitting antenna arrays 204 and transceiver modules 206 may be tuned to frequency bands defined by 5G NR communication standards. Each transmitting antenna array 204 and/or the transceiver module 206 may also be configured to support beamforming for the transmission and reception of communications with a base station (e.g., the base station 120 of FIG. 1), another UE, or other mmWave compatible devices.

The connector(s) 208 (i.e., a radio-frequency (RF) transmission circuit) may include an RF conductor that electrically couples one or more transceiver devices of the transceiver module(s) 206 to one or more antenna elements 205 in the transmitting antenna array(s) 204. Additionally or alternatively, the connector 208 electronically couples a component on the UE 110 (e.g., a processor 214) to another component on the UE 110 (e.g., a modem) (not illustrated). Example types of RF conductors include a transmission cable, a flexible printed circuit board (PCB) having traces, a flex-cable, another mechanism capable of conducting multiple signals.

In aspects, the UE 110 calculates one or more VSWRs (VSWR readings, VSWR measurements, VSWR information, VSWR response) across different antenna element(s) 205 to sense the proximity of an object (e.g., hand, head, body) in the near-field region of one or more transmitting antenna element 205 (e.g., transmitting antenna array(s) 204). As an example, the UE 110 calculates VSWRs across all transmitting antenna elements 205 within the transmitting antenna array(s) 204 to determine whether the changes in calculated VSWRs are the result of simultaneous events (e.g., one object in the near-field region) or different events (e.g., multiple objects in the near-field region alter the impedance matching of multiple antenna elements 205).

The UE 110 measures the power of the forward signal transmitted by one or more antenna elements 205, the power of a reflected signal present in the RF transmission circuit, and calculates a VSWR from the measured power of the forward signal and the measured power of the reflected signal. Based on changes to the measured VSWR, the UE 110 determines the proximity of an object disturbing the RF electromagnetic field emitted by the antenna elements 205 of the UE 110 (e.g., the near-field region of the transmitting antenna element 205). In this manner, the UE 110 can provide proximity detection without the use of a dedicated proximity sensor. This enables the UE 110 to conserve power and resources and provide responsive and reliable object detection. In aspects, the UE 110 measures characteristics of RF signals other than the power of a forward signal and the power of a reflected signal. In other aspects, the UE 110 determines a ratio of the measured characteristics of RF signals other than a VSWR.

In aspects, the UE 110 includes one or more VSWR detectors 210, such as a VSWR detector circuit, a VSWR detector apparatus, and the like. The VSWR detector(s) 210 calculates the VSWR. A VSWR detector 210 measures at least one characteristic of a RF signal (e.g., the forward power (P_{f}), the reflected power (Pᵣ), the effective maximum voltage of the standing wave (Eₘₐₓ), the minimum voltage of the standing wave (Eₘᵢₙ), the maximum current of the standing wave (Iₘₐₓ), the minimum current of the standing wave (Iₘᵢₙ)) and then calculates a ratio of the measured characteristic(s) of the RF signal (e.g., a VSWR). The VSWR detector(s) 210 can take measurements of the characteristics periodically (e.g., every 100 milliseconds). The VSWR detector(s) 210 can take measurements of the characteristics continuously, for example, whenever the transceiver device is transmitting.

A VSWR detector 210 calculates the VSWR for one or more of the antenna elements 205 utilizing a suitable formula, such as formula (1):

$$V S W R = \frac{E max}{E min} . \qquad ( 1 )$$

The measured RF characteristics and/or VSWR readings from one or more antenna elements 205 in an antenna array 204 may be combined, and the combined VSWR reading can be utilized by the UE 110 to detect proximity. In aspects, a calibrated (baseline) value can be determined when no objects are in the near-field region, and this baseline value can be used to determine a threshold value indicative of an object in the near-field region. The UE 110 can monitor the VSWR to determine a change in VSWR that crosses the threshold, indicating the presence of an object in the near-field region.

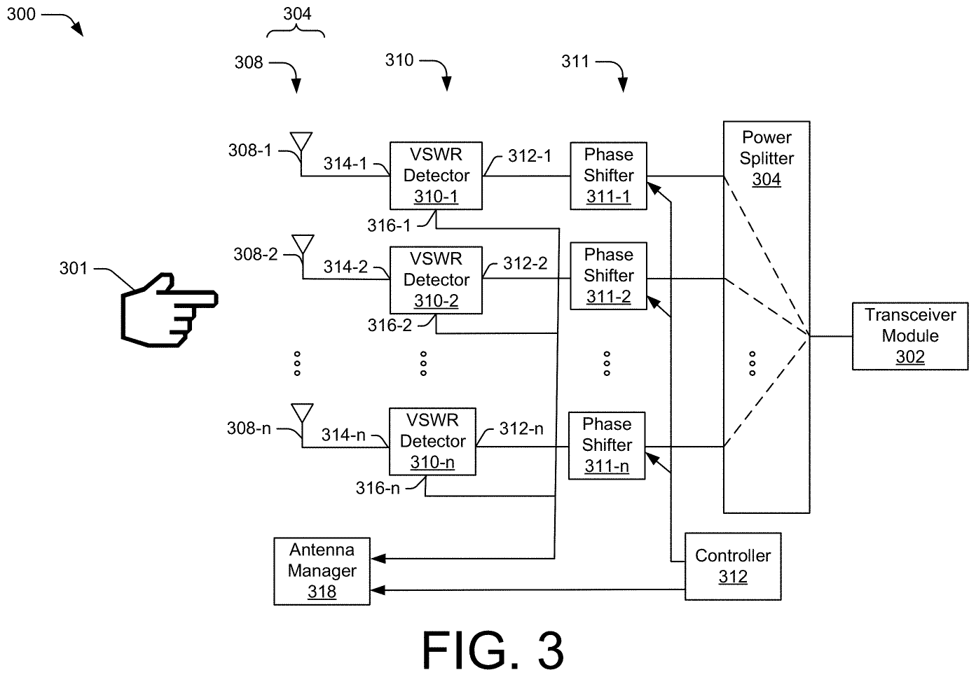

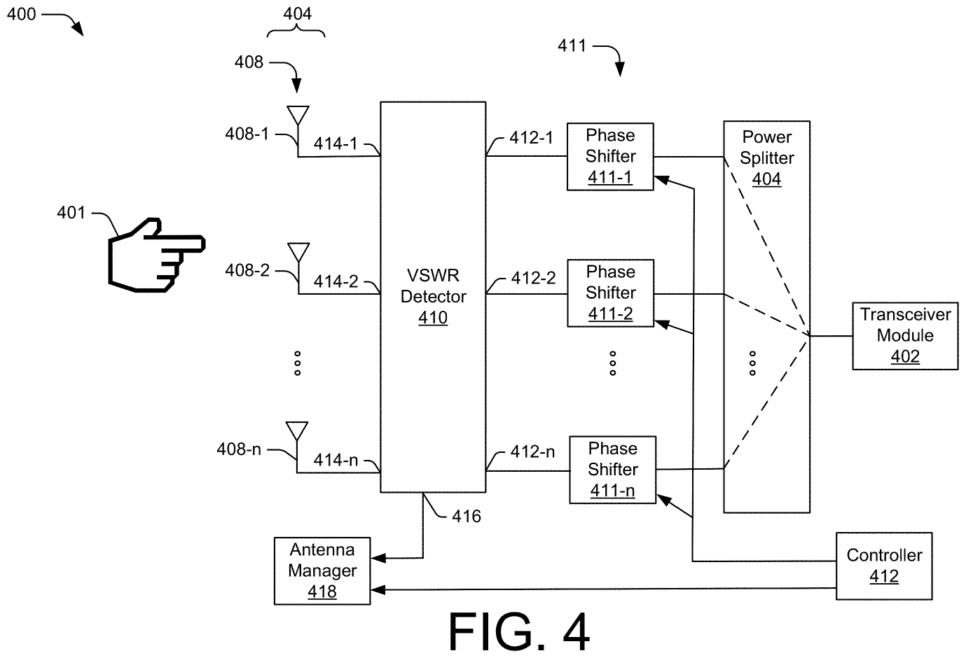

In an example implementation, a separate VSWR detector 210 couples to each antenna element 205, as illustrated with respect to antenna elements 308 in FIG. 3. In another example implementation, a VSWR detector 210 couples to multiple antenna elements 205, as illustrated with respect to antenna elements 408 in FIG. 4. A VSWR detector(s) 210 may include one or more of a processor, an RF detector, a comparator, an attenuator, an amplifier, an analog-to-digital converter, a filter, an interface where the VSWR information is communicated to the processor of the UE 110, and the like.

Whenever an object is present in the near-field of the transmitting antenna element 205, the reflected power back to the transmitting antenna element 205 changes, resulting in a change in the VSWR that can be utilized by the UE 110 (e.g., a VSWR detector 210 implemented on the UE 110) to determine the presence of an object in the near-field region. Further, upon detecting a change in the determined VSWR readings for a first antenna element (e.g., antenna element 408-1 in FIG. 4) and detecting a change in the determined VSWR readings for a second antenna element (e.g., antenna element 408-2 in FIG. 4), the UE 110 (e.g., a VSWR detector 410 implemented on the UE 110) may determine whether the changes are from a simultaneous event (e.g., from the same object in the near-field) or from different events (e.g., different objects in the near-field) by taking a VSWR reading across a plurality of antenna elements 205 (e.g., across the first antenna element and across the second antenna element). The VSWR detectors may provide determined VSWR information to the antenna manager 218.

Examples of VSWR detector(s) 210 include but are not limited to, VSWR detector circuits, VSWR detectors, feedback receivers, coupled power detectors, directionally-coupled power detectors, VSWR meters, and the like. A feedback receiver can be utilized to monitor the power of the forward signal (forward power) and the power of the reflected signal (reflected power). The feedback receiver can then detect a change in the ratio of reflected power over the forward power. A feedback receiver can also be utilized to monitor the phase of the forward signal and the phase of the reflected signal. A directionally-coupled power detector, which includes a directional coupler, can be utilized to sample forward signals and the reflected signals. These sampled radio-frequency signals can be utilized to detect a change in the ratio of reflected power over the forward power. In aspects where the VSWR detector(s) 210 is a directionally-coupled power detector, the power of the forward signal and/or the power of the reflected signal may be measured at an output of a transceiver module 206.

In an instance where the UE 110 is transmitting a signal to a base station 120 or another UE, the UE 110 may employ one or more antenna elements 205 of an antenna array 204 to perform a beamforming operation. Such a beamforming operation may, via principles of constructive and destructive interference, form a directional path to the receiving device. In a beamforming operation, the transmitted beam is shaped by giving different beamforming weights to the antenna elements 205.

For analog beamforming, a controller 212 generates at least one beamforming weight, and at least one phase shifter 211 applies the beamforming weight to the forward signal. For digital beamforming, a device other than a phase shifter 211 (e.g., the processor 214) may be utilized to apply the beamforming weight to the forward signal. The antenna element(s) 205 then transmit the forward signal to which the beamforming weight(s) has been applied. In aspects, each antenna elements 205 within the transmitting antenna array 204 may receive phase-adjusted versions of the forward signal.

In aspects, the controller 212 may include a processor, a computer, and/or a control circuit. The controller 212 may calculate the beamforming weights and indicate the calculated beamforming weights to the phase shifter(s) 211. The controller 212 may provide beamforming information (e.g., the beamforming weights) to an antenna manager 218. In aspects, the controller 212 calculates the proper phase delay for one or more of the antenna elements 205 and provides a beam-steering control signal, which may include phase-shift values, to the phase shifters 211. The controller 212 may be a beam steering computer, an array processor, a digital electronic computer, and the like. In other aspects, the controller 212 may be implemented on the UE 110, for instance as the antenna manager 218 or as a processor(s) 214 of the UE 110.

Also included in the UE 110 is switching circuitry 213 that, in certain instances, may provide switching functions to turn off a radio unit of a transceiver module 206, reduce a transmission power of a radio unit of a transceiver module 206, and/or turn off one or more transmitting antenna elements 205 of the transmitting antenna array 204 responsive to the UE 110 detecting the proximity of an object (e.g., hand, body) in the near-field region of the transmitting antennas. Switching may, in certain instances, alter transmission or reception patterns of the UE 110 and augment beamforming functions of the UE 110.

The UE 110 further includes one or more processor(s) 214 and computer-readable storage media 216 (CRM 216). Each processor 214 may be a single-core processor or a multiple-core processor composed of a variety of materials, such as silicon, polysilicon, high-K dielectric, copper, and so on. The computer-readable storage media described herein excludes propagating signals. CRM 216 may include any suitable memory or storage device such as random-access memory (RAM), static RAM (SRAM), dynamic RAM (DRAM), non-volatile RAM (NVRAM), read-only memory (ROM), or Flash memory. In aspects, the CRM 216 is non-transitory and stores instructions that, responsive to execution by the processor 214, cause the processor 214 to execute the methods described herein.

CRM 216 stores executable instructions of an antenna manager application 218 (antenna manager 218). Alternatively or additionally, the antenna manager application 218 may be implemented in whole or part as hardware logic or circuitry integrated with or separate from other components of the UE 110. In at least some aspects, the antenna manager 218 (e.g., the processor(s) 214 executing the instructions of the antenna manager 218) may configure each antenna array 204, each transceiver module 206, each VSWR detector 210, and/or the switching circuitry 213 in accordance with switching or beamforming operations performed by the UE 110.

The antenna manager 218 may receive beamforming information from the controller 212. The antenna manager application 218 may also receive VSWR readings from the VSWR detector(s) 210. The antenna manager 218 may provide at least one of the beamforming weight information or the VSWR information as input to a machine-learned model 220. In aspects, the antenna manager 218 can control the operation of the VSWR detector(s) 210 or perform operations described herein. In aspects, the antenna manager 218 can operate as the controller 212, controlling beamforming operations on the UE 110.

In aspects, the CRM 216 includes a machine-learned model 220 for detecting the proximity of an object in the near-field region of at least one of transmitting antenna(s), antenna array(s) 204, or antenna elements 205 based on at least one of VSWR information, beamforming weights applied, or a beamforming direction. The machine-learned model 220 may be a standard neural-network-based model with corresponding layers required for processing input features like fixed-side vectors, text embeddings, or variable-length sequences. The machine-learned model 220 may be a support vector machine, a recurrent neural network (RNN), a convolutional neural network (CNN), a dense neural network (DNN), heuristics, or a combination thereof. The machine-learned model 220 can function at an operating system level between the kernel and user spaces.

One or more of measured characteristics of a RF signal (e.g., the forward power (P_{f}), the reflected power (Pᵣ), the effective maximum voltage of the standing wave (Eₘₐₓ), the minimum voltage of the standing wave (Eₘᵢₙ), the maximum current of the standing wave (Iₘₐₓ), the minimum current of the standing wave (Iₘᵢₙ)), calculated ratios of measured characteristic(s) of the RF signal (e.g., a VSWR), changes in calculated ratios of measured characteristic(s) of the RF signal, beamforming information (e.g., beamforming weights, beamforming directions), object information (physical information regarding objects, distance measurements of objects to near-field regions of transmitting antennas), or changes in calculated ratios of measured characteristic(s) of the RF signal resulting from changes to beamforming information, and the like can be collected and categorized with corresponding correct object location and proximity classifications to train the machine-learned model 220.

Through beamforming operations on the UE 110, different beamforming weights can be applied to the forward signal, leading to different VSWR responses to the proximity of an object in the near-field region (e.g., hand, head, body). The VSWR response can then be monitored by the UE 110. In aspects, the beamforming weight applied can be inputted into a machine-learned model 220 trained to determine the proximity of an object in the near-field region from determined VSWR measurements and determined beamforming weights.

After sufficient training, the machine-learned model 220 can be deployed to the CRM 216. The machine-learned model 220 is trained to perform operations including classifying information and generating predictions relating to the presence, proximity, location, and/or movement of an object in the near-field region that are used by the UE 110. For example, the machine-learned model 220 can be trained with one or more of measured characteristics of an RF signal, calculated ratios of measured characteristic(s) of the RF signal, changes in VSWR measurements, beamforming weights, beamforming directions, physical information regarding objects, distance measurements of objects to near-field regions of transmitting antennas, changes in determined VSWR readings resulting from changes to beamforming weights, and the like. The machine-learned model 220 can further be trained with the corresponding correct object presence, proximity, location, and/or movement classifications.

In aspects, one or more VSWR detectors 210 measure VSWR information for one or more antenna elements 205, and these measurements are provided to the antenna manager 218. The controller 212 further provides related beamforming information (e.g., beamforming weights, beamforming directions) to the antenna manager 218. The antenna manager 218 provides the VSWR measurements and beamforming information as inputs to the machine-learned model 220. The machine-learned model 220 is trained to generate a prediction regarding the presence of an object in the near-field region of a transmitting antenna from the VSWR information and beamforming information. As a result, a prediction regarding the presence, proximity, location, and/or movement of an object in the near-field region of a transmitting antenna is obtained from the machine-learned model 220. The UE 110 (e.g., antenna manager 218) can then utilize this prediction to take actions on the UE 110.

In aspects, VSWR information determined by one or more VSWR detectors 210, including but not limited to changes in VSWRs determined, are provided to the antenna manager 218. The antenna manager 218 may provide the VSWR measurement information as inputs to the machine-learned model 220. The machine-learned model 220 is applied to the VSWR measurement information, where the machine-learned model is trained to generate a prediction regarding the presence of an object in the near-field region of a transmitting antenna from the VSWR measurement information. As a result, a prediction regarding the presence, proximity, location, and/or movement of an object in the near-field region of a transmitting antenna is obtained from the model. The antenna manager 218 can then utilize this prediction to take actions on the UE 110.

In aspects, first VSWR measurement information for a first antenna element 205 (e.g., antenna element 408-1 in FIG. 4) of an antenna array 204, measured by a first VSWR detector, and second VSWR measurement information for a second antenna element 205 (e.g., antenna element 408-1 in FIG. 4) of the transmitting antenna array 204, measured by a second VSWR detector, are provided to the antenna manager 218. The antenna manager 218 provides the first and second VSWR measurement information as inputs to the machine-learned model 220. The machine-learned model 220 is trained to generate a prediction regarding the presence of an object in the near-field region of one or more antenna elements 205 in an antenna array 204 from the first and second VSWR measurement information. As a result, a prediction regarding the presence, proximity, location, and/or movement of an object in the near-field region of one or more antenna elements 205 in an antenna array 204 is obtained from the model. The antenna manager 218 can then utilize this prediction to take actions on the UE 110.

FIG. 3 illustrates an example beamforming architecture 300 for the UE 110 that can implement various aspects of proximity detection using determined VSWR readings. The UE 110 may include additional functions and interfaces (e.g., processors, RF amplifiers, power amplifiers, RF filters, mixers) that are omitted from FIG. 3 for the sake of clarity.

In the architecture 300, a separate VSWR detector 310 couples to each antenna element 308 (e.g., antenna element 308-1, antenna element 308-2, antenna element 308-n). In FIG. 3, a transceiver module 302 (e.g., the transceiver module 206 of FIG. 2, a transmitter, a signal generator, a transceiver device, RF source) generates a forward signal for transmission by one or more of the antenna elements 308 of the antenna array 304 (e.g., the transmitting antenna array 204 of FIG. 2). Multiple transceiver modules 302 may be utilized in aspects. The forward signal is for communicating with a base station (e.g., the base station 120 of FIG. 1) or another UE. In aspects, a power splitter 306 is provided for dividing the forward signal.

In aspects, a phase shifter 311 (e.g., the phase shifter 211 of FIG. 2, phase shifter 311-1, phase shifter 311-2, phase shifter 311-n) applies beamforming weights (e.g., phase adjustments, phase shifts) to the forward signal for adjusting the direction and strength of the emitted beam so as to steer the beam pattern emitted by the transmitting antenna array 304 (e.g., antenna array 204 of FIG. 2). In FIG. 3, the phase shifter 311 is a phase-shifter array illustrated as separate phase shifters (phase shifter 311-1, phase shifter 311-2, phase shifter 311-n) disposed between the transceiver module 302 and the respective antenna elements 308. For example, the phase shifter 311-1 is illustrated disposed between transceiver module 302 and antenna element 308-1, the phase shifter 311-2 is illustrated disposed between transceiver module 302 and antenna element 308-2, and the phase shifter 311-n is illustrated disposed between transceiver module 302 and antenna element 308-n. In aspects, a phase shifter 311 may apply a beamforming weight.

A controller 312 (e.g., the controller 212 of FIG. 2) controls the phase shifter(s) 311 through one or more control signals. The control signal(s) may include a beamforming weight for the phase shifter 311 to apply to the forward signal to cause the forward signal transmitted by the antenna elements 308 to be directed in a chosen angular direction (a beamforming direction). The controller 312 may utilize beamforming weights determined by the machine-learned model 220. The controller 312 may provide information (e.g., beamforming weight information, beamforming direction information) to the antenna manager 318.

The respective elements of the antenna array 308 transmit the weighted forward signal. In aspects, the UE 110 includes multiple antenna arrays 304 and each of the multiple antenna arrays may perform, either independently or in unison, beamforming operations as part of wireless communications to and from the UE 110.

The VSWR detector(s) 310 coupled to antenna elements 308 of the transmitting antenna array 304 measures a characteristic(s) of RF signals at a first input port, measures the same characteristic(s) of the RF signals at the first output port, and provides an indication of the ratio of the measured RF signals at an output port. For example, the VSWR detector(s) 310 can be coupled to a transmitting antenna array 304 to measure the power of the forward signal transmitted by one or more antenna elements 308 (antenna element 308-1, antenna element 308-2, antenna element 308-n) of the antenna array 304. The VSWR detector(s) 310 further measure the power of a reflected signal present in the RF transmission circuit. From the measured power of the forward signal and the measured power of the reflected signal, the VSWR detector(s) 310 calculate a VSWR. The VSWR detector(s) 310 can provide calculated VSWR information to the UE 110 (e.g., antenna manager 318). By utilizing a separate VSWR detector(s) 310 for each antenna element 308 (e.g., antenna element 308-1, antenna element 308-2, antenna element 308-n) of the antenna array 304, VSWR information for the transmitting antenna elements 308 can be monitored simultaneously.

In aspects, the forward signals and reflected signals continue to be measured by the VSWR detector(s) 310, which continue to determine the VSWR information until a change in the determined VSWR is detected by the UE 110. A change in the determined VSWRs can be utilized to detect the proximity of an object 301 (e.g., a hand, a head, an extremity, a body) in the near-field region of the transmitting antenna.

In the architecture 300 illustrated in FIG. 3, each VSWR detector 310 (VSWR detector 310-1, VSWR detector 310-2, VSWR detector 310-n) is disposed between a phase shifter 311 (phase shifter 311-1, phase shifter 311-2, phase shifter 311-n) and the respective antenna array 308 element (antenna element 308-1, antenna element 308-2, antenna element 308-n). In aspects, the VSWR detector 310 respectively has a first port (e.g., first port 313-1, first port 313-2, first port 313-n) for receiving a forward signal, a second port 314 (e.g., second port 314-1, second port 314-2, second port 342-n) for receiving a reflected signal, and an output port 316 (e.g., output port 316-1, output port 316-2, output port 316-n) for outputting VSWR information (e.g., an indication of a ratio of the forward signals to their respective reflected signals) to the antenna manager 318 (e.g., antenna manager 218 of FIG. 2).

Through the utilization of beamforming architecture 300, a UE 110 can perform proximity detection apart from utilizing a proximity sensor located on the UE, thereby conserving battery life, freeing resources, and providing responsive and reliable object detection.

FIG. 4 illustrates another example beamforming architecture 400 for the UE 110 that can implement various aspects of proximity detection using VSWR readings. The UE 110 may include additional functions and interfaces (e.g., processors, RF amplifiers, power amplifiers, RF filters, mixers) that are omitted from FIG. 4 for the sake of clarity. In the architecture 400, a single VSWR detector 410 is coupled to (shared across) multiple antenna elements 408 (e.g., antenna element 408-1, antenna element 408-2, antenna element 408-n).

In FIG. 4, the transceiver module 402 (e.g., the transceiver module 206 of FIG. 2, a transmitter, a signal generator, a transceiver device, RF source) generates a forward signal for transmission by one or more of the antenna elements 408 of the antenna array 404 (e.g., the transmitting antenna array 204 of FIG. 2). Multiple transceiver modules 402 may be utilized in aspects. The forward signal for communicating with a base station (e.g., the base station 120 of FIG. 1). In aspects, a power splitter 406 is provided for dividing the forward signal.

In aspects, a phase shifter 411 (e.g., phase shifter 411-1, phase shifter 411-2, phase shifter 411-n) applies beamforming weights (e.g., phase adjustments, phase shifts) to the forward signal for adjusting the direction and strength of the emitted beam so as to steer the beam pattern emitted by the transmitting antenna array 404 (e.g., antenna array 204 of FIG. 2). In FIG. 4, the phase shifter 411 is a phase-shifter array illustrated as separate phase shifters (phase shifter 411-1, phase shifter 411-2, phase shifter 411-n) disposed between the transceiver module 402 and the respective antenna elements 408. For example, phase shifter 411-1 is illustrated disposed between transceiver module 402 and antenna element 408-1, phase shifter 411-2 is illustrated disposed between the transceiver module and antenna element 408-2, and phase shifter 411-n is illustrated disposed between the transceiver module 402 and antenna element 408-n. In aspects, a phase shifter 411 may apply a beamforming weight. In architecture 400, the VSWR detector 410 is disposed between multiple phase shifters 411 (phase shifter 411-1, phase shifter 411-2, phase shifter 411-n) and the respective antenna elements 408 (antenna element 408-1, antenna element 408-2, antenna element 408-n) of the antenna array 404.

A controller 412 (e.g., the controller 212 of FIG. 2) controls the phase shifter(s) 411 through one or more control signals. The control signal(s) may include a beamforming weight for the phase shifter 411 to apply to the forward signal to cause the forward signal transmitted by the antenna elements 408 to be directed in a chosen angular direction (a beamforming direction). The controller 412 may utilize beamforming weights determined by a machine-learned model. The controller 412 may provide information (e.g., beamforming weight information, beamforming direction information) to the antenna manager 418.

The respective elements of the antenna array 408 transmit the weighted forward signal. In aspects, the UE 110 includes multiple antenna arrays 404 and each of the multiple antenna arrays may perform, either independently or in unison, beamforming operations as part of wireless communications to and from the UE 110.

Through the utilization of the beamforming architecture 400, a UE 110 can perform proximity detection apart from utilizing a proximity sensor on the UE 110, thereby conserving battery life, freeing resources, and providing responsive and reliable object detection.

The VSWR detector 410 coupled to antenna elements 408 of the transmitting antenna array 404 measures a characteristic(s) of RF signals at a first input port, measures the same characteristic(s) of the RF signals at the first output port, and provides an indication of the ratio of the measured RF signals at an output port. For example, the VSWR detector 410 can be coupled to the transmitting antenna array 404 to measure the power of the forward signals transmitted by one or more antenna elements 408 (e.g., antenna element 408-1, antenna element 408-2, antenna element 408-n) of the antenna array 404. The VSWR detector 410 further measures the power of reflected signals present in the RF transmission circuit. From the measured power of the forward signals and the measured power of the reflected signals, the VSWR detector 410 calculates VSWRs. The VSWR detector can provide calculated VSWR information to the UE 110 (e.g., antenna manager 418).

By sharing a single VSWR detector 410 across multiple antenna elements 408 (e.g., antenna element 408-1, antenna element 408-2, antenna element 408-n), the transmitting antenna elements 408 can be monitored in a time-division multiplexing (TDM) fashion, giving a measurement of the VSWR from the perspective of a single signal input looking into the beamformed direction. For example, the VSWR detector 410 could monitor the VSWR of the first antenna element 408-1, then the VSWR of the second antenna element 408-2, and so on, on to the VSWR of the nth antenna element 408-n. After monitoring the last antenna element 408-n, the VSWR detector 410 could again monitor the first antenna element 408-1, and so on. In FIG. 4, these multiple antenna elements 408, each with a respective phase shifter 411, can be considered as a single virtual antenna, with the virtual antenna pointing to a particular beamforming direction and using a single VSWR detector to detect that virtual antenna VSWR.

In aspects, measuring the power of the forward signal, by a VSWR detector 410 coupled to the transmitting antenna array 404, includes measuring the power of a plurality of reflected signals from a plurality of antenna elements 408. In aspects, the VSWR detector 410 can take VSWR readings across different antenna elements 408 to determine the proximity of the object 401.

In aspects, the forward signals and reflected signals continue to be measured and the VSWR continues to be determined until a change in the VSWR is detected by the UE 110 (e.g., by the antenna manager 418). The change in the VSWR is then utilized to detect the proximity of an object 401 (e.g., a hand, a head, an extremity, a body) in the near-field region of the transmitting antenna.

In the aspect illustrated in FIG. 4, the VSWR detector 410 has a first port 413-1 for receiving a first forward signal, a first port 413-1 for receiving a second forward signal, and a first port 413-n for receiving an nth forward signal. The VSWR detector 410 further has a second port 414-1 for receiving a first reflected signal from the first antenna element 408-1, a second port 414-2 for receiving a second reflected signal from the second antenna element 408-2, and an nth port 414-n for receiving an nth reflected signal from the nth antenna element 408-n. The VSWR detector 410 also has at least one output port 416 for outputting VSWR information (e.g., indications of the ratio of the forward signals to their respective reflected signals) to an antenna manager 418 (e.g., antenna manager 218 of FIG. 2).

Through the utilization of beamforming architecture 400, a UE 110 can perform proximity detection apart from utilizing a proximity sensor located on the UE 110, thereby conserving battery life, freeing resources, providing responsive and reliable object detection. In aspects, a calibrated (baseline) value can be determined when no objects are in the near-field region, thereby setting a threshold value indicative of an object in the near-field region. The UE 110 can monitor the VSWR to determine a change in VSWR that crosses the threshold, indicating the presence of an object in the near-field region.

Example Methods

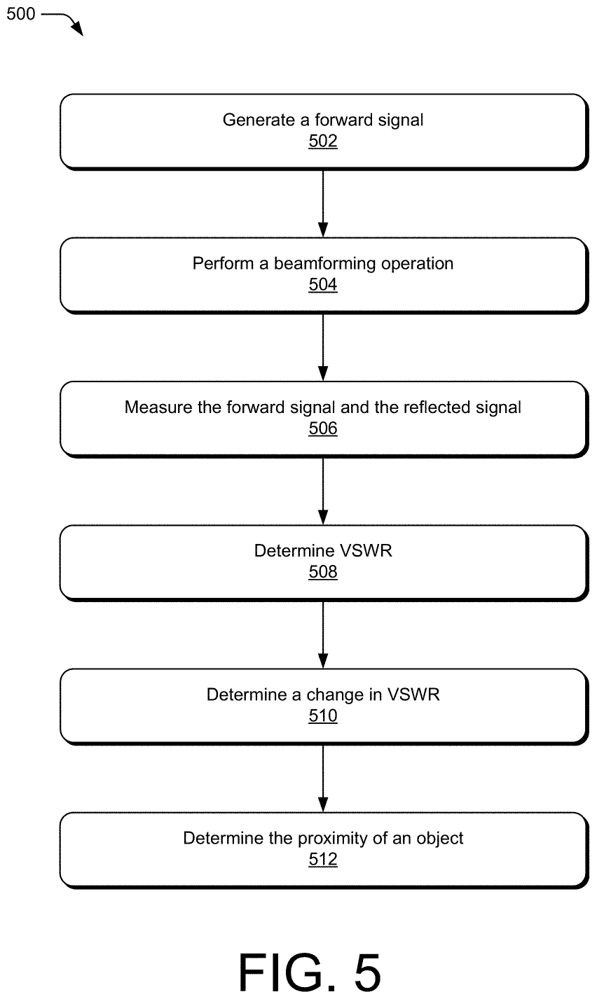

FIG. 5 illustrates an example method 500, implemented by a UE, for proximity detection of an object in a near-field region of an electromagnetic field of a transmitting antenna array of a plurality of antenna elements in accordance with one or more aspects. The UE may be the UE 110 of FIG. 1 and may incorporate elements of FIGS. 2-4. In aspects, the transmitting antenna array is a mmWave antenna array and the antenna elements are mmWave antenna elements. The antenna array may be a phased array.

At 502, the UE generates a forward signal for transmission by the plurality of antenna elements 205. In certain instances, the forward signal is generated by a transceiver device (e.g., a transmitter, RF source, signal generator) of a transceiver module 206. The transceiver module 206 may be within a mmWave antenna module 202. In aspects, a plurality of forward signals is generated by a plurality of transceiver devices.

At 504, the UE performs a beamforming operation. In certain instances, a controller 212 of the UE 110 generates a beamforming weight and a phase shifter 211 applies the beamforming weight to the forward signal. The weighted forward signal is then transmitted by the corresponding antenna element 205 of the transmitting antenna array 204.

At 506, the UE measures a power of the forward signal and measures a power of the reflected signal. In certain instances, the measurements are performed by at least one VSWR detector 210 coupled to the transmitting antenna array 204. In certain instances, a separate VSWR detector 210 couples to each of the transmitting antenna elements 205. In certain instances, a single VSWR detector 210 takes VSWR readings across different antenna elements 205.

At 508, the UE determines a VSWR from the measured power of the forward signal and the measured power of the reflected signal. In certain instances, at least one VSWR detector 210 determines a VSWR on the UE 110.

At 510, the UE determines a change in the VSWR. In certain instances, the UE 110 iteratively measures subsequent forward signals and subsequent reflected signals, and determines VSWRs until a change in the VSWR is detected. In certain instances, the UE 110 determines a VSWR resulting from an applied beamforming weight. In certain instances, the determined VSWRs for different antenna elements 205 are compared to determine whether the VSWR change is from a simultaneous event or from different events.

At 512, the UE utilizes the detected change in VSWR to detect the proximity of the object in the near-field region. In certain instances, a machine-learned model 220 is applied to the determined VSWR information. The machine-learned model 220 is trained to determine the proximity of the object 301 or 401 in the near-field region from the determined VSWR information. In certain instances, a machine-learned model 220 is applied to the determined VSWR information and the determined beamforming weights, the machine-learned model 220 trained to determine the proximity of the object 301 or 401 in the near-field region from determined VSWR information and the determined beamforming weights.

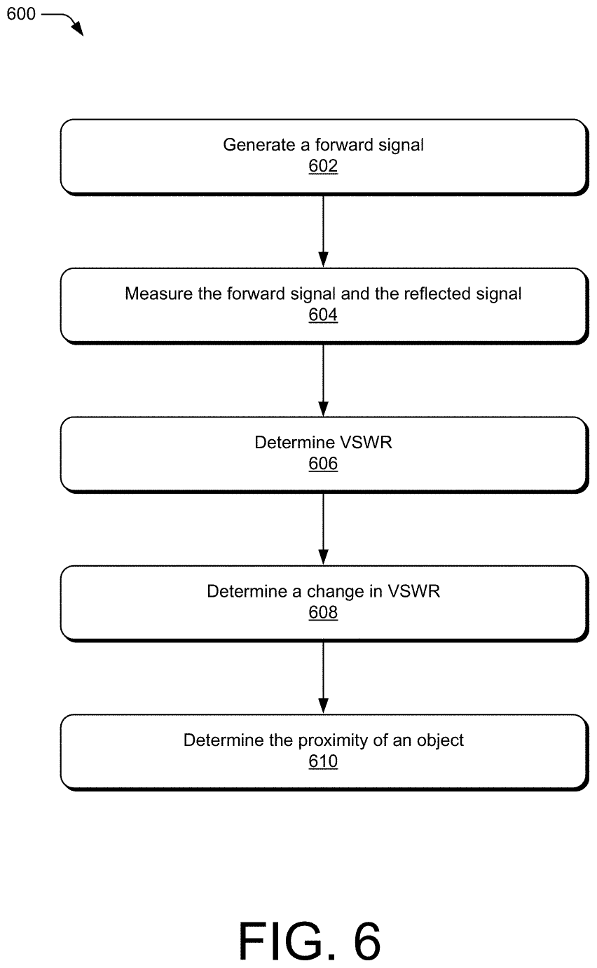

FIG. 6 illustrates an example method 600, implemented by a UE, for proximity detection of an object in a near-field region of an electromagnetic field of a transmitting antenna array of a plurality of antenna elements in accordance with one or more aspects. The UE may be the UE 110 of FIG. 1 and may incorporate elements of FIGS. 2-4. In aspects, the transmitting antenna array is a mmWave antenna array, and the antenna elements are mmWave antenna elements. The antenna array may be a phased array.

At 602, the UE generates a forward signal for transmission by the plurality of antenna elements. In certain instances, the forward signal is generated by a transceiver device (e.g., a transmitter, RF source, signal generator) of a transceiver module 206. The transceiver module 206 may be within a mmWave antenna module 202. In aspects, a plurality of forward signals is generated by a plurality of transceiver devices. The forward signal is then transmitted by the transmitting antenna array 204.

At 604, the UE measures a power of the forward signal and measures a power of the reflected signal. In certain instances, the measurements are performed by a plurality of VSWR detectors 210, where each VSWR detector 210 couples to one of the transmitting elements of the transmitting antenna array.

At 606, the UE determines a VSWR from the measured power of the forward signal and the measured power of the reflected signal. In certain instances, at least one VSWR detector 210 determines a VSWR on the UE 110.

At 608, the UE determines a change in the VSWR. In certain instances, the UE 110 iteratively measures subsequent forward signals and subsequent reflected signals, and determines the VSWR until a change in the VSWR is detected. In certain instances, the UE determines a VSWR response resulting from an applied beamforming weight. In certain instances, the determined VSWRs for different antenna elements 205 are compared to determine whether the VSWR change is from a simultaneous event or from different events.

At 610, the UE utilizes the detected change in VSWR to detect the proximity of the object in the near-field region. In certain instances, a machine-learned model 220 is applied to the determined VSWRs. The machine-learned model 220 is trained to determine the proximity of the object 301 or 401 in the near-field region from detected VSWR information. In certain instances, a machine-learned model 220 is applied to both the determined VSWR information and the determined beamforming weights. In this instance, the machine-learned model 220 is trained to determine the proximity of the object in the near-field region from both the determined VSWR information and the determined beamforming weights.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, Field-Programmable Gate Arrays (FPGAs), Application-Specific Integrated Circuits (ASICs), Application-Specific Standard Products (ASSPs), System-on-a-Chip systems (SoCs), Complex Programmable Logic Devices (CPLDs), and the like. The order in which the method blocks are described in these Figures is not intended to be construed as a limitation, and any number of the described method blocks can be combined in any order to implement a method, or an alternate method.

Although aspects of proximity detection of an object in a near-field region of an electromagnetic field of a transmitting antenna, such as an antenna array of a plurality of antenna elements, using VSWR have been described in language specific to features and/or methods, the subject of the appended claims is not necessarily limited to the specific features or methods described. Rather, the specific features and methods are disclosed as example implementations of proximity detection of an object in a near-field region of an electromagnetic field of a transmitting antenna, such as an antenna array of a plurality of antenna elements, using VSWR, and other equivalent features and methods are intended to be within the scope of the appended claims. Further, various different aspects are described, and it is to be appreciated that each described aspect can be implemented independently or in connection with one or more other described aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

### Examples

In the following paragraphs, some examples are described.

Example 1: A method for proximity detection of an object in a near-field region of an electromagnetic field of a millimeter-wave transmitting antenna array (204; 304; 404) formed from a plurality of millimeter-wave antenna elements (205; 308, 408), the method comprising: generating (502; 602) a forward signal for transmission by the plurality of antenna elements; generating, by a controller (212; 312; 412), beamforming weights; applying (504), by phase shifters (211; 311; 411), the beamforming weights to the forward signal to generate a weighted forward signal; measuring (506; 604), by at least one voltage standing wave ratio detector (210; 310; 410) coupled to the transmitting antenna array, a power of the weighted forward signal; transmitting the weighted forward signal; measuring (506; 604), by the at least one voltage standing wave ratio detector, a power of a reflected signal; calculating (508; 606), by the at least one voltage standing wave ratio detector, a voltage standing wave ratio based on the power of the weighted forward signal and the power of the reflected signal; detecting (510; 608) a change in the voltage standing wave ratio by iteratively measuring subsequent weighted forward signals, measuring subsequent reflected signals, and determining the voltage standing wave ratio; and detecting (512; 610) the proximity of the object in the near-field region based on the detected change in the voltage standing wave ratio.

Example 2: The method of example 1, wherein the measuring of the power of the weighted forward signal is performed by a separate voltage standing wave ratio detector (310-1; 310-2; 310-n) coupled to each of the plurality of antenna elements (205).

Example 3: The method of any preceding example, wherein the calculating of the voltage standing wave ratio further comprises calculating, by the at least one voltage standing wave ratio detector (210; 310; 410), a plurality of voltage standing wave ratios across the plurality of antenna elements to determine the proximity of the object.

Example 4: The method of any preceding example, further comprising further measuring the subsequent weighted forward signals, further measuring the subsequent reflected signals, and determining a voltage standing wave ratio resulting from the applied beamforming weights for the plurality of antenna elements.

Example 5: The method of claim 3, wherein the detecting the proximity of the object in the near-field region comprises comparing a first voltage standing wave ratio of the plurality of voltage standing wave ratios to a second voltage standing wave ratio of the plurality of voltage standing wave ratios; the first voltage standing wave ratio is associated with a first antenna element of the plurality of antenna elements; and the second voltage ratio is associated with a second antenna element of the plurality of antenna elements.

Example 6: The method of claim 5, further comprising: determining that a change in the first voltage standing wave ratio and a change in the second voltage standing wave ratio is caused by a same object; or determining that the change in the first voltage standing wave ratio and the change in the second voltage standing wave ratio is caused by multiple objects in the near-field region.

Example 7: The method of any preceding example, further comprising: responsive to detecting the proximity of the object in the near-field region, performing, by a processor (214), an operation, wherein the operation is at least one of: turning off a radio unit of a transceiver module (206; 302; 402); reducing a transmission power of the radio unit; or turning off one or more of the plurality of antenna elements (205; 308, 408) of the transmitting antenna array (204; 304; 404).

Example 8: The method of any preceding example, wherein the VSWR detector (210; 310; 410) comprises at least one of: a feedback receiver measuring the power of the weighted forward signal; a coupled power detector measuring the power of the weighted forward signal; or a voltage standing wave ratio meter measuring the power of the weighted forward signal.

Example 9: The method of any preceding example, wherein the measuring of power of the weighted forward signal is performed by a voltage standing wave ratio detector (210; 310; 410) comprising a directionally-coupled power detector; and the measuring of the power of the reflected signal comprises measuring the power of the reflected signal at an output of a transceiver module (206; 302; 402).

Example 10: The method of example 5 or 6, wherein the detecting of the proximity of the object in the near-field region further comprises applying a machine-learned model (220) to the determined voltage standing wave ratio, where the machine-learned model is trained to determine the proximity of the object in the near-field region from the voltage standing wave ratio; and obtaining, from the machine-learned model, a detected proximity of the object in the near-field region.

Example 11: The method of example 10, further comprising steering, by the transmitting antenna array (204; 304; 404), the weighted forward signal using the beamforming weights; and wherein the applying of the machine-learned model (220) further comprises applying the machine-learned model (220) to both the determined voltage standing wave ratio and the determined beamforming weights, where the machine-learned model is trained to determine the proximity of the object in the near-field region from both the determined voltage standing wave ratio and the determined beamforming weights.

Example 12: A user device (110) comprising: a processor (214); and a computer-readable storage medium (216) having stored thereon instructions that, responsive to execution by the processor, cause the processor to execute the method of any of preceding example.

Example 13: The method of example 7, wherein the transceiver module (206; 302; 402) is within a millimeter-wave antenna module.

Example 14: The method of any preceding example, wherein the transmitting antenna array (204; 304; 404) comprises a phased array.

Example 15: The method of any preceding example, wherein the measuring of the power of the reflected signal comprises measuring the power of a plurality of reflected signals from the plurality of antenna elements (205; 308, 408).

Example 16: A method for proximity detection of an object in a near-field region of an electromagnetic field of a millimeter-wave transmitting antenna array (204; 304; 404) formed from a plurality of millimeter-wave antenna elements (205; 308; 408), the method comprising: generating (602) a forward signal for transmission by the plurality of antenna elements; measuring (604), by a plurality of voltage standing wave ratio detectors (210; 310), a power of the forward signal at each antenna element of the plurality of antenna elements, wherein each voltage standing wave ratio detector couples to one of the antenna elements; transmitting the forward signal; measuring (604), by each voltage standing wave ratio detector, a power of a reflected signal at each of the antenna elements; calculating (606), by each voltage standing wave ratio detector, a voltage standing wave ratio for each of the antenna elements based on the power of the measured forward signal and the power of the measured reflected signal; detecting (608) a change in the voltage standing wave ratio by iteratively measuring subsequent forward signals, measuring subsequent reflected signals, and determining the voltage standing wave ratios; and detecting (610) the proximity of the object in the near-field region based on the detected change in the voltage standing wave ratio.

Example 17: The method of example 16, further comprising: generating, by a controller (212; 312), beamforming weights; and applying, by phase shifters (211; 311) respectively associated with the plurality of antenna elements, the beamforming weights to the forward signal to generate a weighted forward signal.

Example 18: The method of example 17, further measuring the subsequent forward signals, further measuring the subsequent reflected signals, and determining the voltage standing wave ratio resulting from the applied beamforming weights.

Example 19: The method of any of examples 16 to 18 wherein the detecting of the proximity of the object in the near-field region comprises comparing a first determined voltage standing wave ratio associated with a first antenna element to a second voltage standing wave ratio associated with a second antenna element.

Example 20: The method of any of example 19, further comprising at least one of: determining that a change in the first voltage standing wave ratio and a change in the second voltage standing wave ratio is caused by a single object within the near-field region; or determining that the change in the first voltage standing wave ratio and the change in the second voltage standing wave ratio is caused by multiple objects within the near-field region.

Example 21: The method of any of examples 16 to 20, further comprising: responsive to detecting the proximity of the object in the near-field region, performing, by a processor (214), an operation, wherein the operation is at least one of: turning off a radio unit of a transceiver module (206; 302; 402); reducing a transmission power of the radio unit; or turning off one or more antenna elements of the antenna array.

Example 22: the method of any of examples 16 to 21, wherein the plurality of voltage standing wave ratio detectors (210; 310) comprises at least one of: a feedback receiver measuring the power of the weighted forward signal; a coupled power detector measuring the power of the weighted forward signal; or a voltage standing wave ratio meter measuring the power of the weighted forward signal.

Example 23: The method of any of examples 16 to 22, wherein the measuring (604) of the power of the forward signal at each antenna element of the plurality of antenna elements and the measuring (604) of the power of a reflected signal at each of the antenna elements are performed by a plurality of voltage standing wave ratio detectors (210; 310) comprising directionally-coupled power detectors; and the method further comprising at least one of: measuring the power of the forward signal at an output of a transceiver module (206; 302; 402) by the directionally-coupled power detectors; or measuring the power of the reflected signal at an output of a transceiver module (206; 302; 402) by the directionally-coupled power detectors.

Example 24: The method of any of examples 16 to 23, wherein the detecting of the proximity of the object in the near-field region further comprises: applying a machine-learned model (220) to the determined voltage standing wave ratios, where the machine-learned model is trained to determine the proximity of the object in the near-field region from the voltage standing wave ratios; and obtaining, from the machine-learned model, a detected proximity of the object in the near-field region.

Example 25: The method one of any of examples 24, further comprising steering the transmitting antenna array (204; 304; 404) using beamforming weights, wherein: the detecting of the proximity of the object in the near-field region further comprises determining the beamforming weights associated with the transmitting antenna array; and the applying of the machine-learned model (220) further comprises applying the machine-learned model (220) to both the determined voltage standing wave ratios and the determined beamforming weights, where the machine-learned model is trained to determine the proximity of the object in the near-field region from both the determined voltage standing wave ratio and the determined beamforming weights.

Example 26: The method of any of examples 24 or 25, further comprising providing, by a controller (212; 312; 412), beamforming information to an antenna manager (218); providing, by the plurality of voltage standing wave ratio detectors (210; 310), the determined voltage standing wave ratios to the antenna manager; or providing, by the antenna manager (218), the beamforming weights and the determined voltage standing wave ratios as input to the machine-learned model.

Example 27: The method of any of examples 16 to 26, wherein the transceiver module (302; 402) is within a millimeter-wave antenna module.

Example 28: The method of any of examples 16 to 27, wherein the antenna array (204; 304; 404) comprises a phased array.

Example 29: A user device comprising: a processor (214); and a computer-readable storage medium (216) having stored thereon instructions that, responsive to execution by the processor, cause the processor to execute the method of any of examples 16 to 28.

1. A method comprising:
generating a forward signal for transmission by a plurality of millimeter-wave antenna elements;
generating, by a controller, beamforming weights;
applying, by phase shifters, the beamforming weights to the forward signal to generate a weighted forward signal;
measuring, by at least one voltage standing wave ratio detector coupled to a millimeter-wave transmitting antenna array formed from the plurality of millimeter-wave antenna elements, a power of the weighted forward signal;
transmitting the weighted forward signal;
measuring, by the at least one voltage standing wave ratio detector, a power of a reflected signal;
calculating, by the at least one voltage standing wave ratio detector, a voltage standing wave ratio based on the power of the weighted forward signal and the power of the reflected signal;
detecting a change in the voltage standing wave ratio by iteratively measuring subsequent weighted forward signals, measuring subsequent reflected signals, and determining the voltage standing wave ratio; and
detecting a proximity of an object in a near-field region of an electromagnetic field of the transmitting antenna array based on the detected change in the voltage standing wave ratio.

2. The method of claim 1, wherein:
the measuring of the power of the weighted forward signal is performed by a separate voltage standing wave ratio detector coupled to each of the plurality of antenna elements.

3. The method of claim 1, wherein:
the calculating of the voltage standing wave ratio further comprises calculating, by the at least one voltage standing wave ratio detector, a plurality of voltage standing wave ratios across the plurality of antenna elements to determine the proximity of the object.

4. The method of claim 1, further comprising:
further measuring the subsequent weighted forward signals, further measuring the subsequent reflected signals, and determining a voltage standing wave ratio resulting from the applied beamforming weights for the plurality of antenna elements.

5. The method of claim 3, wherein:
the detecting the proximity of the object in the near-field region comprises comparing a first voltage standing wave ratio of the plurality of voltage standing wave ratios to a second voltage standing wave ratio of the plurality of voltage standing wave ratios;
the first voltage standing wave ratio is associated with a first antenna element of the plurality of antenna elements; and
the second voltage ratio is associated with a second antenna element of the plurality of antenna elements.

6. The method of claim 5, further comprising at least one of:
determining that a change in the first voltage standing wave ratio and a change in the second voltage standing wave ratio is caused by a same object; or
determining that the change in the first voltage standing wave ratio and the change in the second voltage standing wave ratio is caused by multiple objects in the near-field region.

7. The method of claim 1, further comprising:
responsive to detecting the proximity of the object in the near-field region, performing, by a processor, an operation,
wherein the operation is at least one of:
turning off a radio unit of a transceiver module;
reducing a transmission power of a radio unit; or
turning off one or more of the plurality of antenna elements of the transmitting antenna array.

8. The method of claim 1, wherein:
the voltage standing wave ratio detector comprises at least one of:
a feedback receiver measuring the power of the weighted forward signal;
a coupled power detector measuring the power of the weighted forward signal; or
a voltage standing wave ratio meter measuring the power of the weighted forward signal.

9. The method of claim 1, wherein:
the measuring of a power of the weighted forward signal is performed by a voltage standing wave ratio detector comprising a directionally-coupled power detector; and
the measuring of the power of the reflected signal comprises:
measuring the power of the reflected signal at an output of a transceiver module.

10. The method of claim 5, wherein:
the detecting of the proximity of the object in the near-field region further comprises:
applying a machine-learned model to the determined voltage standing wave ratio, where the machine-learned model is trained to determine the proximity of the object in the near-field region from the voltage standing wave ratio; and
obtaining, from the machine-learned model, a detected proximity of the object in the near-field region.

11. The method of claim 10, further comprising:
steering, by the transmitting antenna array, the weighted forward signal using the beamforming weights; and
wherein the applying of the machine-learned model further comprises applying the machine-learned model to both the determined voltage standing wave ratio and the applied beamforming weights, where the machine-learned model is trained to determine the proximity of the object in the near-field region from both the determined voltage standing wave ratio and the applied beamforming weights.

12-24. (canceled)

25. A user device comprising:
a controller;
a millimeter-wave transmitting antenna array formed from a plurality of millimeter-wave antenna elements;
at least one phase shifter;
at least one voltage standing wave ratio detector, the voltage standing wave ratio detector coupled to the transmitting antenna array;
a processor; and
a computer-readable storage medium having stored thereon instructions that, responsive to execution by the processor, perform operations comprising:
generate a forward signal for transmission by the plurality of millimeter-wave antenna elements;
generate, by the controller, beamforming weights;
apply, by the at least one phase shifter, the beamforming weights to the forward signal to generate a weighted forward signal;
measure, by the least one voltage standing wave ratio detector, a power of the weighted forward signal;
transmit the weighted forward signal;
measure, by the at least one voltage standing wave ratio detector, a power of a reflected signal;
calculate, by the at least one voltage standing wave ratio detector, a voltage standing wave ratio based on the power of the weighted forward signal and the power of the reflected signal;
detect a change in the voltage standing wave ratio by iteratively measuring subsequent weighted forward signals, measuring subsequent reflected signals, and determining the voltage standing wave ratio; and
detect a proximity of an object in a near-field region of an electromagnetic field of the transmitting antenna array based on the detected change in the voltage standing wave ratio.

26. The user device of claim 25, wherein the at least one voltage standing wave ratio detector further comprises:
a separate voltage standing wave ratio detector coupled to each of the plurality of antenna elements.

27. The user device of claim 25, wherein the operation of calculate the voltage standing wave ratio based on the power of the weighted forward signal and the power of the reflected signal further comprises the processor performing an operation comprising:
calculate a plurality of voltage standing wave ratios across the plurality of antenna elements.

28. The user device of claim 27, wherein the operation of detect the proximity of an object in the near-field region based on the detected change in the voltage standing wave ratio further comprises the processor performing an operation comprising:
comparing a first voltage standing wave ratio of the plurality of voltage standing wave ratios to a second voltage standing wave ratio of the plurality of voltage standing wave ratios, the first voltage standing wave ratio associated with a first antenna element of the plurality of antenna elements, the second voltage ratio associated with a second antenna element of the plurality of antenna elements.

29. The user device of claim 28, wherein the processor performs operations further comprising at least one of:
determine that a change in the first voltage standing wave ratio and a change in the second voltage standing wave ratio is caused by a same object; or
determine that the change in the first voltage standing wave ratio and the change in the second voltage standing wave ratio is caused by multiple objects in the near-field region.

30. The user device of claim 28,
wherein the processor further performs an operation comprising determine a voltage standing wave ratio resulting from the applied beamforming weights for the plurality of antenna elements, and
wherein the operation of detect the proximity of the object in the near-field region based on the detected change in the voltage standing wave ratio further comprises the processor performing operations comprising:
apply a machine-learned model to the determined voltage standing wave ratio, where the machine-learned model is trained to determine the proximity of the object in the near-field region from the voltage standing wave ratio; and
obtain, from the machine-learned model, a detected proximity of the object in the near-field region.

31. The user device of claim 30,
wherein the processor further performs operations comprising steering, by the transmitting antenna array, the weighted forward signal using the beamforming weights, and
wherein the applying of the machine-learned model further comprises applying the machine-learned model to both the determined voltage standing wave ratio and the applied beamforming weights, where the machine-learned model is trained to determine the proximity of the object in the near-field region from both the determined voltage standing wave ratio and the applied beamforming weights.

32. The user device of claim 25, wherein the processor further performs an operation comprising:
determine a voltage standing wave ratio resulting from the applied beamforming weights for the plurality of antenna elements.

33. The user device of claim 25, wherein responsive to the processor detecting the proximity of the object in the near-field region, the processor further performs operations comprising at least one of:
turning off a radio unit of a transceiver module;
reducing a transmission power of a radio unit; or
turning off one or more of the plurality of antenna elements of the transmitting antenna array.
